(19) United States
(12) Patent Application Publication
(10) Pub. No.: US 2015/0375517 A1
(43) Pub. Date: Dec. 31, 2015

(54) PRINTER AND CONSUMABLES

(71) Applicant: RISO KAGAKU CORPORATION, Tokyo (JP)

(72) Inventors: Yasushi KURATANI, Ibaraki (JP); Atsushi HIROSHIMA, Ibaraki (JP)

(73) Assignee: RISO KAGAKU CORPORATION, Tokyo (JP)

(21) Appl. No.: 14/742,883

(22) Filed: Jun. 18, 2015

(30) Foreign Application Priority Data
Jun. 30, 2014 (JP) 2014-133969

(51) Int. Cl. B41J 2/175

(52) U.S. Cl. CPC B41J 2/17546

(57) ABSTRACT

If an authentication unit authenticates the consumables manager, a determination unit determines whether or not a ink cartridge is past a recommended use-by date, which is calculated from the manufacturing date the recommended stop period and the like, based on the recommended use-by date and the number of days that have elapsed since the manufacturing date of the ink cartridge. Then, a notification unit displays a message as a warning on an operation panel, the message indicating that the ink cartridge is close to its use-by date, if the determination unit determines that the ink cartridge is past the recommended use-by date, and if the warning cycle has passed since the warning point of the last warning issuance judged from the warning information stored in a memory in the ink cartridge and the warning cycle stored in a memory.

### BACKGROUND

1. Technical Field

The present invention relates to a printer and a consumable item for notifying a consumables manager that the consumable item is close to its use-by date, at timing that does not bother the consumables manager.

2. Related Art

An ink jet printer is provided with detachable ink cartridges having inks of respective colors stored therein. The ink-jet printer prints images, characters, and the like by supplying the inks to ink-jet heads from the ink cartridges and ejecting the inks onto printing paper from nozzles in the ink-jet heads.

For many consumable items such as the ink cartridges as described above, a use-by date is set as a period to guarantee the quality. Thus, a general ink jet printer calculates a use-by date based on a manufacturing date and a duration of use stored in the ink cartridge, and, if the currently used ink cartridge is past its use-by date, displays a warning to that effect.

Patent Document 1 proposes an image formation apparatus configured as follows. After a consumable item is detected having only a predetermined amount of time left before the end of its life (a state of the consumable item shortly before the consumable item reaches a completely unusable state; hereinafter referred to as the “near life”), and before the consumable item is detected reaching the end of its life (the completely unusable state; hereinafter referred to as the “life”), the image formation apparatus displays a warning encouraging replacement of the consumable item on a display unit provided in the apparatus when power-on of the apparatus or cancellation of a power-saving mode is detected.

### PRIOR ART DOCUMENT

### Patent Documents

[Patent Document 1] Japanese Patent No. 3951996

### SUMMARY

However, in an ink-jet recording apparatus described in Patent Document 1, since after a consumable item is detected having only a predetermined amount of time left before the end of its life (near life), and before the consumable item is detected reaching the end of its life (“life”), a warning encouraging replacement of the consumable item is displayed on the display unit provided in the apparatus when power-on of the apparatus or cancellation of a power-saving mode is detected, the warning encouraging replacement of the consumable item is displayed every time the power-on of the apparatus or cancellation of the power-saving mode is detected.

Before the consumable item is detected reaching the end of its life (life) after the consumable item is detected having only a predetermined amount of time left before the end of its life (life), printing can be continued without immediately replacing the consumable item. For this reason, it can be said that the urgency of warning display is lower than that after the end of the life.

If the warning encouraging the replacement of the consumable item is repeatedly displayed during such a period, every time the power-on of the apparatus or cancellation of the power-saving mode is detected, the user feels bothered by such warning display.

Moreover, in general, it is often the case that a consumables manager is determined beforehand as a person in charge of managing consumable items, and the consumables manager performs consumables management, such as replenishing the consumable items, using a purchase management system or the like.

Ehen the consumables manager performs the consumables management using the purchase management system or the like as described above, there is a possibility that the consumables manager may not be appropriately notified of a warning encouraging replacement of a consumable item, because the ink-jet recording apparatus described in Patent Document 1 displays the warning not to a specific user but to every user. For example, when a general user performs power-on of the apparatus or cancels the power-saving mode and the consumables manager does not perform the power-on of the apparatus or cancellation of the power-saving mode for a long time, the warning encouraging replacement of the consumable item is not displayed to the consumables manager. Moreover, when the general user who has seen the warning forgets to tell the consumables manager about the warning display of the consumable item, the consumables manager has no way of knowing that the consumable item have reached the time for replacement.

The present invention is made in view of the aforementioned problems. It is an object of the present invention to provide a printer and a consumable item for notifying a consumables manager that the consumable item is close to its use-by date, at timing that does not bother the consumables manager.

In order to achieve the above object, a first aspect of a printer according to the present invention is a printer including a main body device configured to perform printing and a consumable item detachably attached to the main body device and used for printing, comprising: an authentication unit configured to authenticate a consumables manager who manages the consumable item; a determination unit configured to determine whether or not the consumable item is past a recommended use-by date which is to come before a use-by date of the consumable item, based on a manufacturing date or use start date of the consumable item, the recommended use-by date, and time that has passed since the manufacturing date or use start date of the consumable item; a notification unit configured to notify the authenticated consumables manager of a warning content indicating that the consumable item is close to the use-by date, under a predetermined condition if the authentication unit authenticates the consumables manager and the determination unit determines that the consumable item is past the recommended use-by date; and a storage unit configured to store an interval of notification by the notification unit as a notification cycle, and store a notification point of the most recent notification by the notification unit after the recommended use-by date, wherein the predetermined condition includes when the notification point is not stored in the storage unit, or when the notification point is stored in the storage unit and the notification cycle has passed since the notification point.

A second aspect of the printer according to the present invention is that the storage unit stores the notification cycle that is a first predetermined period indicating a period of one or a multiple of unit period, and a second predetermined period included in the first predetermined period, and the predetermined condition includes when the notification point is not stored in the storage unit, or when the notification point is stored in the storage unit, the notification cycle has passed since the notification point, and the current timing is after the second predetermined period within the first predetermined period.

A third aspect of the printer according to the present invention is that the printer further includes a stock information storage unit configured to store in-stock information indicating that the consumable item is in stock, wherein if the authentication unit authenticates the consumables manager and the determination unit determines that the consumable item is past the recommended use-by date, the notification unit notifies the authenticated consumables manager of the warning content under the predetermined condition and additionally under a condition where the in-stock information is not stored in the stock information storage unit.

A first aspect of a consumable item according to the present invention is a consumable item detachably attached to a main body device including: an authentication unit configured to authenticate a consumables manager who manages the consumable item; a determination unit configured to determine whether or not the consumable item is past a recommended use-by date which is to come before a use-by date of the consumable item, based on a manufacturing date or use start date of the consumable item, the recommended use-by date, and time that has passed since the manufacturing date or use start date of the consumable item; a notification unit configured to notify a warning content indicating that the consumable item is close to the use-by date, under a predetermined condition if the authentication unit authenticates the consumables manager and the determination unit determines that the consumable item is past the recommended use-by date; and a storage unit configured to store an interval of notification by the notification unit as a notification cycle, the consumable item comprising: a notification point storage unit configured to store a notification point of the most recent notification by the notification unit after the recommended use-by date, as notification point information, wherein the predetermined condition includes when the notification point information is not stored in the notification point storage unit or when the notification point information is stored in the notification point storage unit and the notification cycle has passed since the notification point.

A second aspect of the consumable item according to the present invention is that the storage unit stores the notification cycle that is a first predetermined period indicating a period of one or a multiple of unit period, and a second predetermined period included in the first predetermined period, and the predetermined condition includes when the notification point information is not stored in the notification point storage unit, or when the notification point information is stored in the notification point storage unit, the notification cycle has passed since the notification point, and the current timing is after the second predetermined period within the first predetermined period.

A third aspect of the consumable item according to the present invention is that the consumable item further include a stock information storage unit configured to store in-stock information indicating that the consumables are in stock, wherein if the authentication unit authenticates the consumables manager and the determination unit determines that the consumable item is past the recommended use-by date, the notification unit notifies the authenticated consumables manager of the warning content under the predetermined condition and additionally under a condition where the in-stock information is not stored in the stock information storage unit.

### BRIEF DESCRIPTION OF DRAWINGS

FIG. 1 is a diagram showing a configuration of an ink-jet printer according to an embodiment of the present invention;

FIG. 2 is an explanatory diagram showing functions of the ink-jet printer according to the embodiment of the present invention;

FIG. 3 is a diagram showing an example of a duration of use and a recommended stop period stored in a memory in the ink-jet printer according to the embodiment of the present invention;

FIG. 4 is a diagram explaining the duration of use and the recommended stop period in the ink-jet printer according to the embodiment of the present invention;

FIG. 5 is a diagram explaining in detail operations of a determination unit and a notification unit included in the ink-jet printer according to the embodiment of the present invention;

FIG. 6 is a diagram explaining in detail the operations of the notification unit included in the ink-jet printer according to the embodiment of the present invention;

FIG. 7 is a flowchart showing steps of processing in the ink jetprinter according to the embodiment of the present invention; and

FIG. 8 is a diagram explaining in detail operations of a notification unit in modified example 1 of the present invention.

### DETAILED DESCRIPTION

Hereinafter, with reference to the drawings, an embodiment of the present invention is described in detail.

In the embodiment of the present invention, description is given taking as an example an ink-jet printer including a main body device and ink cartridges of respective colors detachably attached to the main body device. The ink-jet printer performs printing by ejecting inks supplied from the ink cartridges to ink-jet heads included in the main body device.

### <Configuration of Ink-Jet Printer>

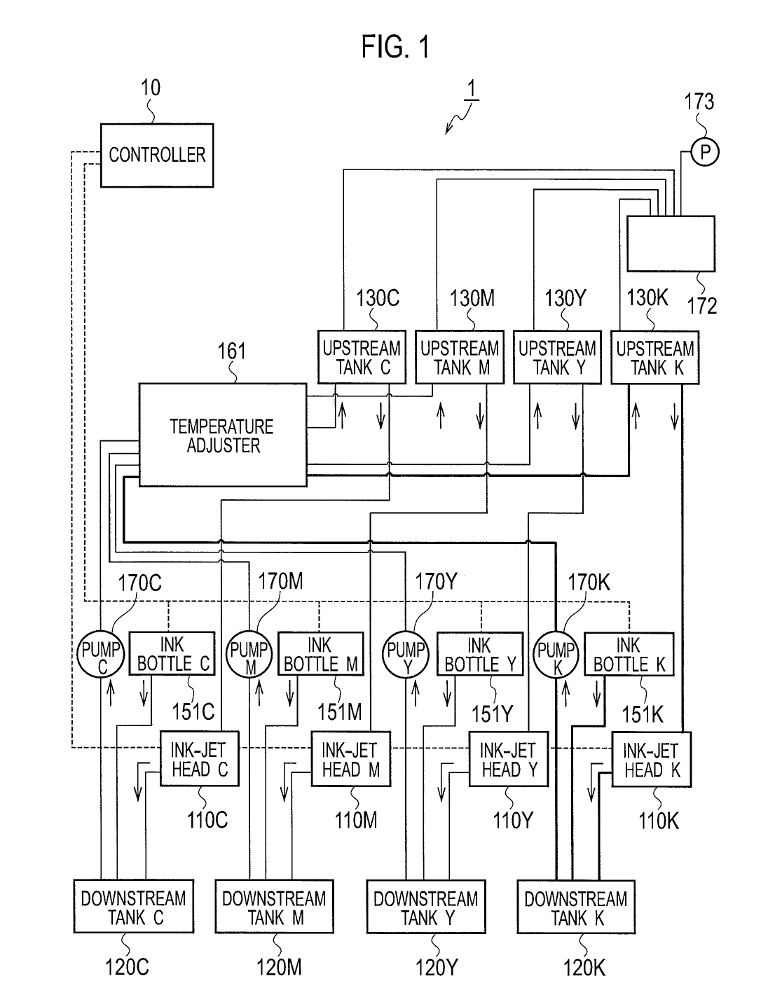

FIG. 1 is a diagram showing a configuration of an ink jet printer 1 according to the embodiment of the present invention.

The ink-jet printer 1 according to the embodiment of the present invention includes ink cartridges and a main body device having a configuration other than the ink cartridges. In FIG. 1, description is given taking as an example the ink-jet printer 1 in a state where the ink cartridges are attached to the main body device.

As shown in FIG. 1, the ink jet printer 1 includes ink-jet heads 110C, 110M, 110Y and 110K corresponding to C (cyan), M (magenta), Y (yellow) and K (black) inks, respectively. Printing paper is printed line by line with the inks ejected from the ink jet heads 110C, 110M, 110Y and 110K while being transferred at a speed set according to printing conditions by an annular transfer belt (not shown) provided on opposite surfaces of the ink jet heads 110C, 110M, 110Y and 110K.

Each of the ink cartridges is configured so as to be detachable from the main body device, and includes an ink bottle storing the ink and a non-contact IC storing various kinds of information about the ink.

The respective inks are supplied from the ink bottles. An ink bottle 151C supplying the C (cyan) ink, an ink bottle 151M supplying the M (magenta) ink, an ink bottle 151Y supplying the Y (yellow) ink, and an ink bottle 151K supplying the K (black) ink are provided. Note that, in the following description, the ink bottles are collectively referred to as the ink bottles 151 when the color of the ink does not matter. The same goes for the other functional units.

The inks supplied from the ink bottles 151 pass through ink circulating paths formed of pipes made of resin, metal or the like, and are then once stored in downstream tanks provided on the downstream side of the ink-jet heads 110. Thus, the ink-jet printer 1 includes a downstream tank 120C storing the C (cyan) ink, a downstream tank 120M storing the M (magenta) ink, a downstream tank 120Y storing the Y (yellow) ink, and a downstream tank 120K storing the K (black) ink.

The ink jet printer 1 further includes pumps 170C, 170M, 170Y and 170K and upstream tanks 130C, 130M, 130Y and 130K. The inks stored in the downstream tanks 120 are sent to the upstream tanks provided on the upstream side of the ink-jet heads 110 by the pumps. The inks sent to the upstream tanks 130 are then sent to the ink jet heads 110 each having a number of nozzles provided therein to eject the ink.

The upstream tanks 130 are connected to a common air chamber 172. The common air chamber 172 is provided with a pump 173 and an unillustrated atmospheric air open valve. The air pressures in the upstream tanks 130 are adjusted by fully closing the atmospheric air open valve and sending air into the upstream tanks 130 by the pump 173 or by fully opening the atmospheric air open valve to set the air pressures in the upstream tanks to the atmospheric pressure.

The inks not ejected from the ink-jet heads 110 are returned to the downstream tanks 120. For ink return to the downstream tanks 120 from the upstream tanks 130 through the ink-jet heads 110, a water head difference between the upstream tanks 130 and the downstream tanks 120 is used.

For the inks, a temperature range that guarantees print quality is specified. When the ambient temperature is low and an ink temperature is below a lower limit temperature at which printing can be performed, the ink needs to be heated. Meanwhile, a driver and a piezoelectric element provided in each of the ink-jet heads 110 generate heat when operated. Thus, the influence and the like of such heat and Joule heat generated by ink vibration on ink temperature rise at high temperature need to be suppressed. Therefore, a temperature adjuster 161 is provided on the ink circulating paths, and the inks are heated or cooled by the temperature adjuster 161.

The ink-jet printer 1 further includes a controller 10 configured to control the main body device. The controller 10 has a function to transfer data, through wireless communication, to the ink cartridges attached to the main body device. The controller 10 also detects power-on of the ink jet printer 1 or return from a power-saving mode. Here, the power-saving mode is a mode in which warning screen display to be described later is disabled to suppress power consumption, and is a sleep mode with reduced power consumption, for example. The return from the power-saving mode means a shift from the sleep mode to a normal mode that allows printing.

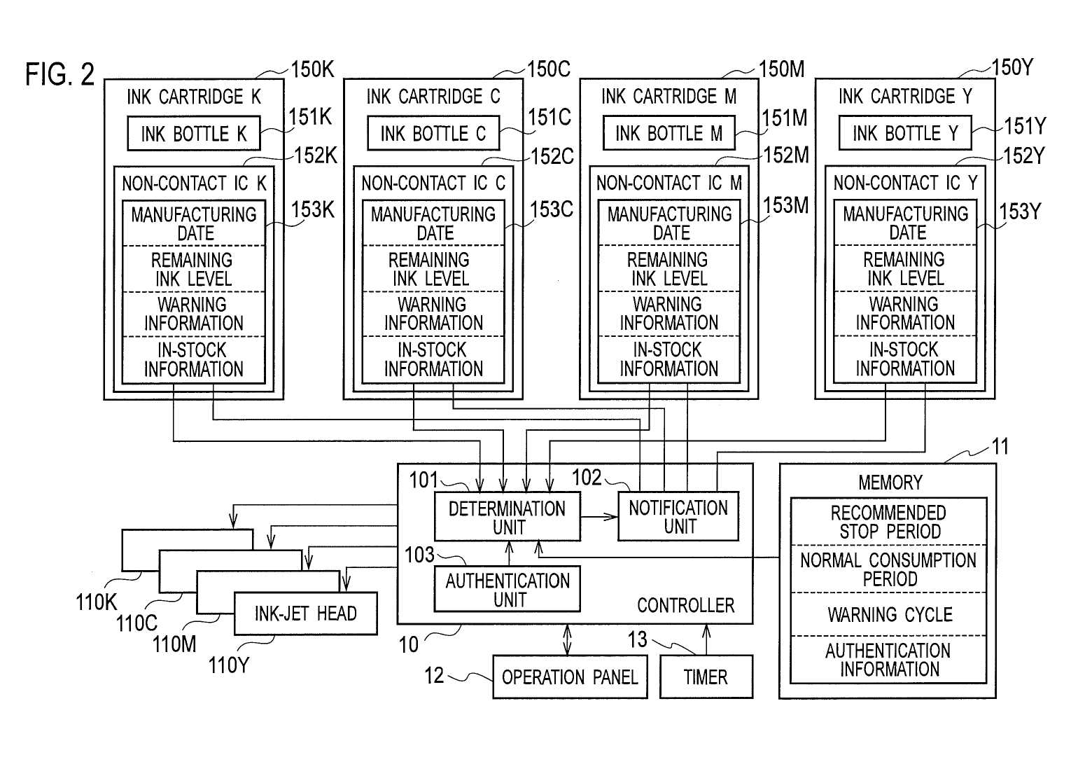

FIG. 2 is an explanatory diagram showing functions of the ink jet printer 1 according to the embodiment of the present invention.

As shown in FIG. 2, the ink-jet printer 1 according to the embodiment of the present invention includes: ink cartridges 150K, 150C, 150M and 150Y; the controller 10 provided in the main body device; the ink-jet heads 110K, 110C, 110M and 110Y provided in the main body device; a memory 11; an operation panel 12; and a timer 13. Note that, since the ink-jet heads 110K, 110C, 110M and 110Y are described above, description thereof is omitted here. Note that, although description is given here taking as an example the ink cartridge 150K corresponding to the K (black) ink, the same goes for the inks of the other ink colors.

The ink cartridge 150K corresponding to the K (black) ink includes the ink bottle 151K and the non-contact IC (reference numeral 152K).

The non-contact IC (reference numeral 152K) has a memory 153K and performs wireless data communication with the controller 10 in the main body device.

The memory 153K stores a manufacturing date on which the ink cartridge 150K was manufactured, a remaining level of the ink stored in the ink bottle 151K, warning information indicating the date of issuance of a warning, and in-stock information indicating that the ink cartridge 150K is in stock. Note that the remaining ink level can be calculated by subtracting an ejection amount from the ink-jet head 110, and the like from an initial amount, for example. Moreover, as for the warning information, an initial value thereof is a “null” value (blank) and, when a warning is issued, the date of the issuance of the first warning is written. Then, every time a warning is issued, the date is overwritten and updated with the date of issuance of the new warning. As for the in-stock information, an initial value thereof is a “null” value (blank) and, when a consumables manager performs an operation to show that the ink cartridge 150K is in stock, the in-stock information is written.

Likewise, each of the ink cartridges 150C, 150M and 150Y corresponding to the C (cyan), M (magenta) and Y (yellow) inks also stores the manufacturing date, remaining ink level, warning information and in-stock information, and performs wireless data communication with the controller 10 in the main body device.

For each of the ink cartridges 150K, 150C, 150M and 150Y, the memory 11 stores a normal consumption period indicating a period for which the ink cartridge is normally usable, and a recommended stop period that is a period for which the ink cartridge is usable but replacement thereof is recommended.

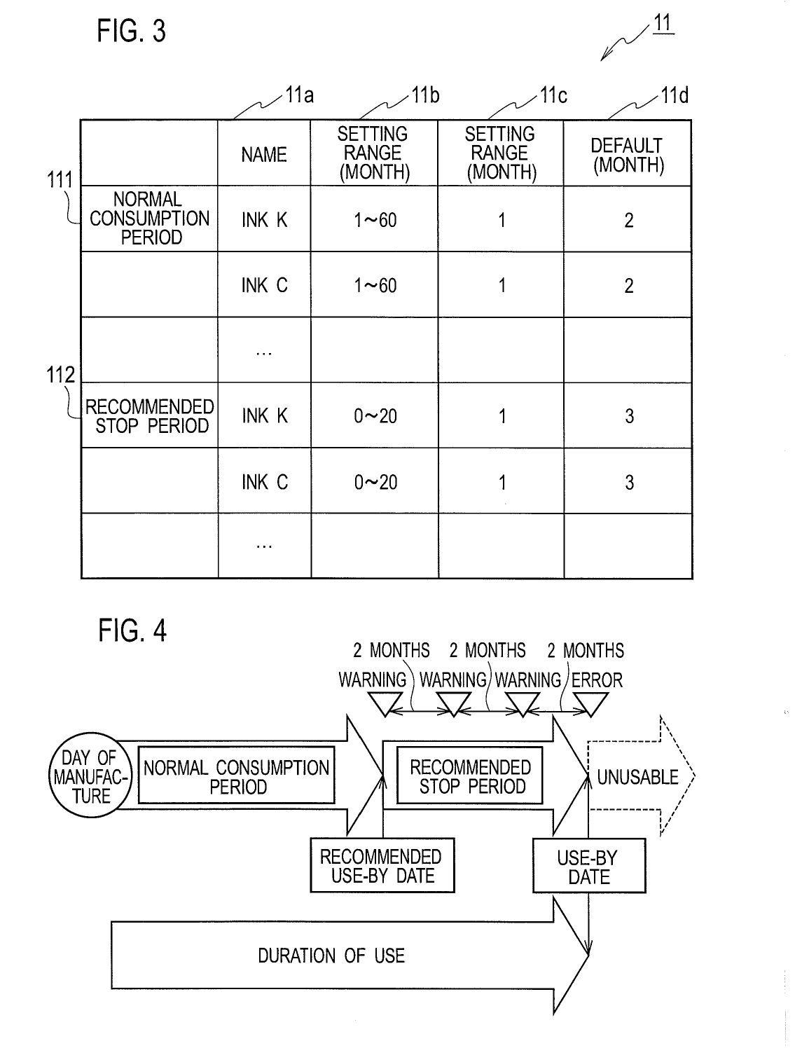

FIG. 3 is a diagram showing an example of the normal consumption period and recommended stop period stored in the memory 11 in the ink jetprinter 1 according to the embodiment of the present invention.

As shown in FIG. 3, as for the normal consumption period 111, a setting range 11b (unit: month) indicating a range to which the normal consumption period 111 can be set, a setting unit 11c (unit: month) that is a unit that can be set, and a default 11d (unit: month) when no period is set are associated with each other and stored for each name 11a of the ink colors, C (cyan), M (magenta), Y (yellow) and K (black).

Likewise, as for the recommended stop period 112, a setting range 11b (unit: month) indicating a range to which the recommended stop period 112 can be set, a setting unit 11c (unit: month) that is a unit that can be set, and a default 11d (unit: month) when no period is set are associated with each other and stored for each name 11a of the ink colors, C (cyan), M (magenta), Y (yellow) and K (black).

The memory 11 also stores a warning cycle indicating a warning issuance interval and authentication information regarding the consumables manager. In the warning cycle, a set value indicates one or a multiple of the length of one month. For example, if the value in the warning cycle is set to “2”, a warning is issued every other month. Such every other month issuance is described in detail later.

As the authentication information, a user ID of the consumables manager that is a user who manages consumable items, and a password, for example, are associated with each other and stored.

FIG. 4 is a diagram explaining the normal consumption period and the recommended stop period.

As shown in FIG. 4, for each of the ink cartridges 150K, 150C, 150M and 150Y, the manufacturing date is stored in the memory included in the non-contact IC. The point when the normal consumption period, that is the period for which the ink cartridge can be used without any problem, has passed since the manufacturing date is set to be a recommended use-by date. As described later, after the ink cartridge is past the recommended use-by date, a warning is issued for each warning cycle (here, every other month) for the recommended stop period close to a use-by date, in which replacement of the ink cartridge is recommended. Then, the point when the recommended stop period has passed since the recommended use-by date is the use-by date. Since the ink cartridge which is past its use-by date cannot be used, an error is issued. The period from the manufacturing date to the use-by date is a duration of use.

Referring back to FIG. 2, the operation panel 12 including an operation screen and a touch panel is connected to the controller 10. The operation panel 12 is disposed in the upper part of the ink-jet printer 1. The operation panel 12 can be used as an input operation unit or the like for the user to input setting conditions for processing contents such as the number of sheets to be printed in the case of copying a print image set in an unillustrated scanner unit or in the case of printing a print job received from the outside.

The operation panel 12 receives the user ID and the password based on a user operation. Thus, the consumables manager can be authenticated.

The operation panel 12 further receives setting operations for the recommended use-by date, the warning cycle and the like, based on a user operation. The controller 10 reflects the setting operations onto the memory 11.

The timer 13 is connected to the controller 10, and acquires the manufacturing date stored in the non-contact IC through the controller 10. The timer 13 counts the number of days that have elapsed since the manufacturing date.

The controller 10 that causes the ink-jet heads 110C, 110M, 110Y and 110K to perform printing operations is an arithmetic processor including a processor such as a CPU and a DSP, a memory, and hardware such as other electronic circuits, or software such as a program having functions thereof, or a combination thereof. The controller 10 virtually builds various functional modules by appropriately reading and executing programs, thereby performing processing for image data, operation control for the respective units, and various processing for the user operations.

To be more specific, the controller 10 builds the functional modules, including a determination unit 101, a notification unit 102 and an authentication unit 103. Note that the “module” used in this embodiment is formed of hardware such as a device and equipment, software having functions thereof or a combination thereof, and means a functional unit to achieve a predetermined operation.

The authentication unit 103 determines, based on the authentication information stored in the memory 11, whether or not the user ID and password inputted from the operation panel 12 by the user operation coincide with the user ID and password stored in the authentication information. When the inputted user ID and password coincide with the user ID and password stored in the authentication information, it means that the authentication of the consumables manager has succeeded. On the other hand, when the inputted user ID and password do not coincide with the user ID and password stored in the authentication information, it means that the authentication of the consumables manager has failed.

The determination unit 101 determines whether or not the ink cartridge 150 is past the recommended use-by date, based on the manufacturing date of the ink cartridge 150, the recommended use-by date before the use-by date of the ink cartridge 150, and the number of days that have elapsed since the manufacturing date of the ink cartridge 150.

When the authentication unit 103 authenticates the consumables manager and the determination unit 101 determines that the ink cartridge 150 is past the recommended use-by date, the notification unit 102 notifies the authenticated consumables manager of a warning indicating that the ink cartridge 150 is close to its use-by date under predetermined conditions.

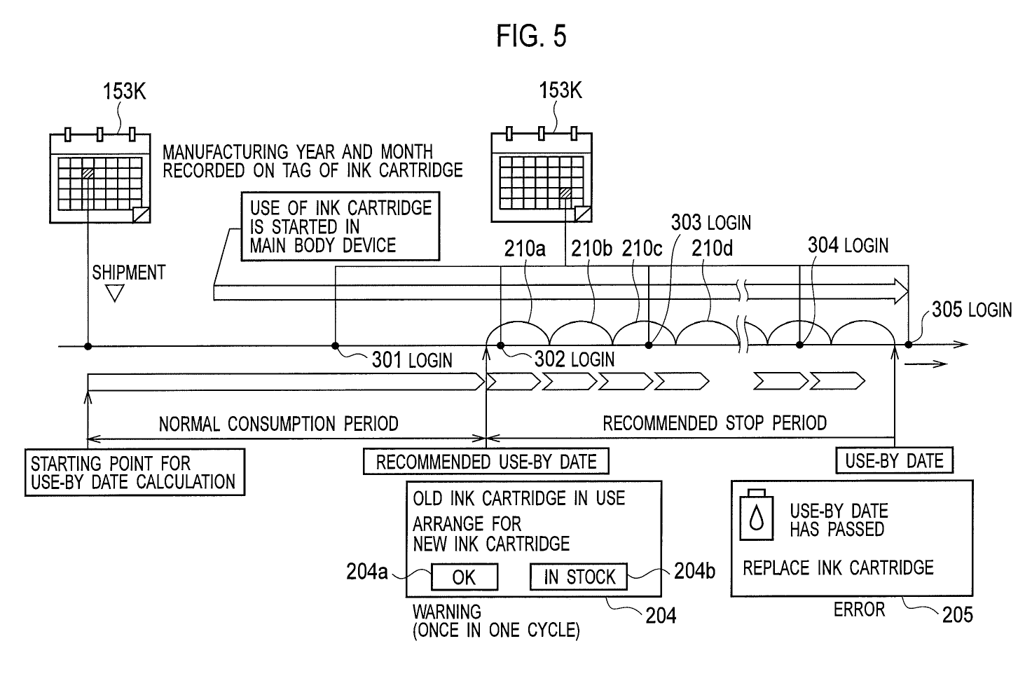

FIG. 5 is a diagram explaining in detail operations of the determination unit 101 and the notification unit 102. Note that, although description is given here taking as an example the K (black) ink, the same goes for the other ink colors.

As shown in FIG. 5, here, the manufacturing date stored in the memory 153K in the ink cartridge 150K is used as the starting point for use-by date calculation.

Also, the point when the normal consumption period has passed since the manufacturing date is set to be the recommended use-by date. Moreover, the period from the recommended use-by date to the use-by date is set to be the recommended stop period.

The determination unit 101 determines whether or not the ink cartridge 150K is past the recommended use-by date, which is calculated based on the manufacturing date stored in the memory 153K in the ink cartridge 150K, the normal consumption period of the ink cartridge 150K stored in the memory 11, and the like, based on the recommended use-by date, and the number of days that have elapsed since the manufacturing date of the ink cartridge 150K counted by the timer 13.

Then, the notification unit 102 displays a message as a warning on the operation panel 12, the message indicating that the ink cartridge is close to its use-by date, when the authentication unit 103 authenticates the consumables manager, the determination unit 101 determines that the ink cartridge 150K is past the recommended use-by date, and predetermined conditions are met. To be more specific, when no warning information is stored in the memory 153K in the ink cartridge 150K, the notification unit 102 displays a message as a warning on the operation panel 12, the message indicating that the ink cartridge is close to its use-by date. On the other hand, when warning information is stored in the memory 153K in the ink cartridge 150K, and the warning cycle has passed since the warning point when a warning had been issued, the notification unit 102 displays a message as a warning on the operation panel 12, the message indicating that the ink cartridge is close to its use-by date.

For example, since the point when a login 301 of the consumables manager is operated is within the normal consumption period, and is not past the recommended use-by date, the notification unit 102 displays no warning on the operation panel 12.

On the other hand, the point when a login 302 of the consumables manager is operated is within the recommended stop period, and is past the recommended use-by date. Moreover, when no warning has been issued at the point when the login 302 of the consumables manager is operated, no warning information is stored in the memory 153K and thus the notification unit 102 displays a message as a warning on the operation panel 12, the message indicating that the ink cartridge 150K is close to its use-by date. As shown in a warning screen example 204, for example, a message such as “Old ink cartridge in use. Arrange for new ink cartridge.” is displayed on the operation panel 12.

The warning screen example 204 includes: an OK button 204a to be pressed when arrangement for the ink cartridge 150 is not completed and the ink cartridge is out of stock; and an in-stock button 204b to be pressed when arrangement for the ink cartridge 150 is completed and the ink cartridge is in stock.

More specifically, when the consumables manager presses the in-stock button 204b in the warning screen example 204, the controller 10 stores in-stock information in the memory 153 corresponding to the ink cartridge for which the warning is issued, among the memories 153K, 153C, 153M and 153Y in the ink cartridges 150K, 150C, 150M and 150Y. Meanwhile, when the consumables manager presses the OK button 204a in the warning screen example 204, the controller 10 deletes the warning screen example 204 without storing in-stock information.

Thereafter, the past point when a login 303 of the consumables manager is operated is within the recommended stop period, and is past the recommended use-by date. Moreover, at the point when the login 303 of the consumables manager is operated, a warning has been issued at the point when the login 302 of the consumables manager is operated. Thus, warning information is stored in the memory 153K. In this event, when the warning cycle is set to “2” (months), the point when the login 302 of the consumables manager is operated is in the month 210a, and the point when the login 303 of the consumables manager is operated is in the month (the month past the warning cycle) that is “2” (months) after the month 210a. Thus, a warning is issued also at the point when the login 303 of the consumables manager is operated.

Since the ink cartridge 150 past the use-by date that is the point when the recommended stop period has passed since the recommended use-by date can no longer be used, the notification unit 102 issues an error. A login point 305 of the consumables manager is past the use-by date. Thus, the notification unit 102 displays a message as an error on the operation panel 12, the message indicating that the ink cartridge 150K is past its use-by date. The error message is, for example, “Use-by date has passed. Replace ink cartridge.” as shown in an error screen example 205.

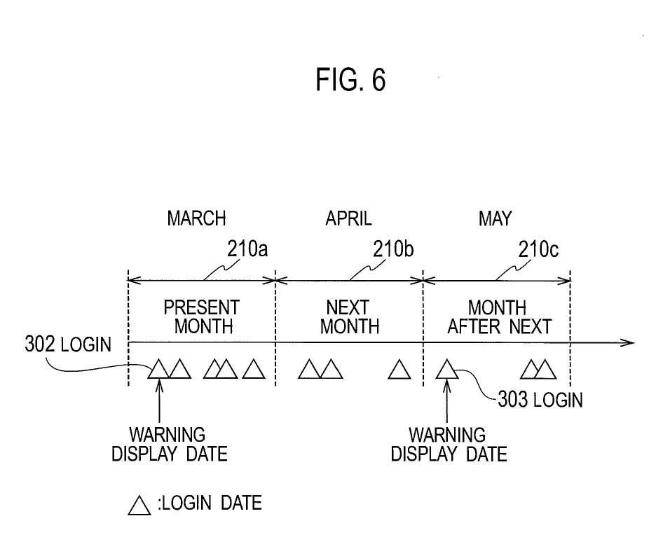

FIG. 6 is a diagram explaining in more detail the operations of the notification unit 102.

In FIG. 6, for the purpose of illustration, it is assumed that the month 210a is “3” (March), the month 210b is “4” (April) and the month 210c is “5” (May). When the login 302 of the consumables manager is operated in March, the notification unit 102 displays a message, on the operation panel 12, indicating that the ink cartridge 150K is close to its use-by date.

Thereafter, no warnings are issued until two months pass (“month” changes by “2”) from the point when the last warning is issued, i.e., when the login 302 of the consumables manager is operated, even if a login operation of the consumables manager is performed. In other words, no warnings are issued when a login operation of the consumables manager is performed in March after the point when the login 302 of the consumables manager is operated or when a login operation of the consumables manager is performed in April.

The month that is two months after March that is the month in which the last warning is issued, i.e., the login 302 of the consumables manager is operated is May. Thus, the second warning is issued at the point of a first login of the consumables manager in May, i.e., when the login 303 of the consumables manager is operated.

### <Operations of Ink-Jet Printer>

Next, description is given of operations of the ink jet printer 1 according to the embodiment of the present invention.

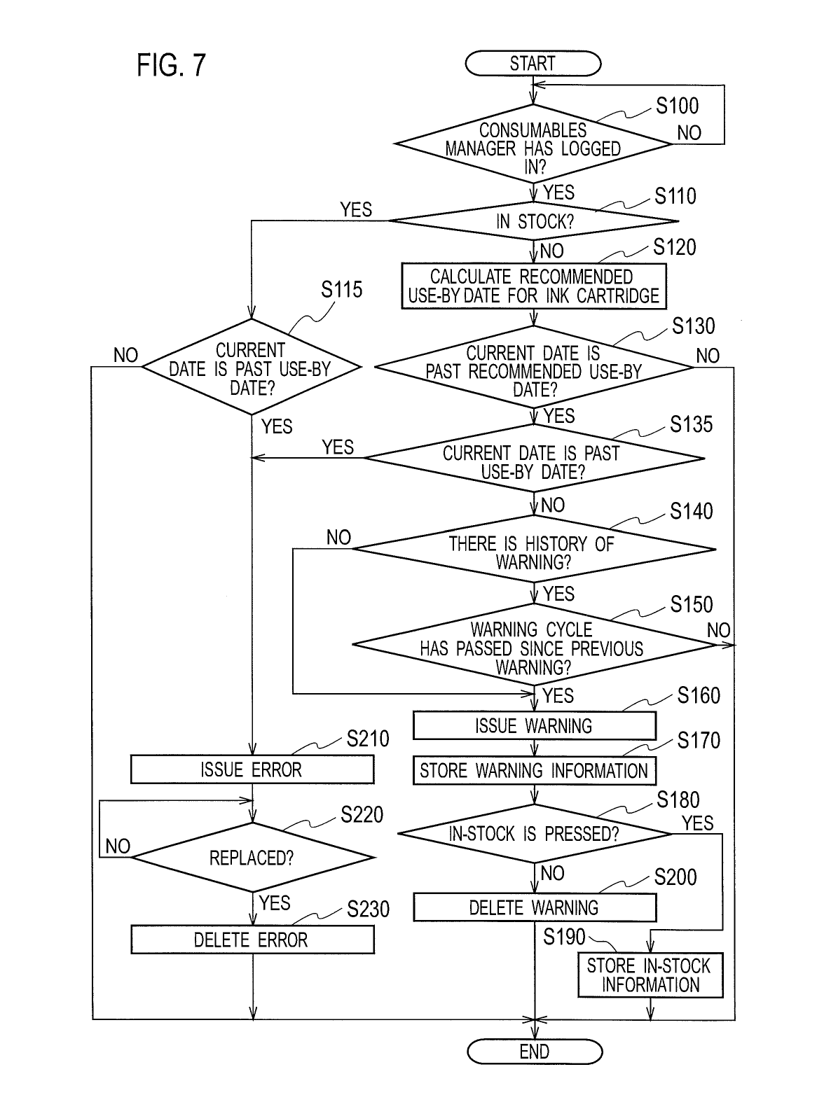

FIG. 7 is a flowchart showing steps of processing in the ink jet printer 1 according to the embodiment of the present invention. Note that, although description is given here taking as an example the K (black) ink, the same goes for the other ink colors.

As shown in FIG. 7, the ink-jet printer 1 according to the embodiment of the present invention first determines whether or not the consumables manager has logged in (Step S100). To be more specific, when the operation panel 12 receives a user ID and a password based on a user operation, the authentication unit 103 determines, based on the authentication information stored in the memory 11, whether or not the user ID and password inputted from the operation panel 12 by the user operation coincide with the user ID and password stored in the authentication information. When the user IDs and the passwords coincide with each other, it means that the authentication (login) of the consumables manager has succeeded. On the other hand, when the user IDs and the passwords do not coincide with each other, it means that the authentication (login) of the consumables manager has failed.

When it is determined in Step S100 that the consumables manager has logged in (YES), the notification unit 102 determines whether or not the ink cartridge 150K is in stock (Step S110). To be more specific, when in-stock information is stored in the memory 153K, the notification unit 102 determines that the ink cartridge 150K is in stock.

When it is determined in Step S110 that the ink cartridge 150K is out of stock (NO), the controller 10 starts wireless communication with the non-contact IC (reference numeral 152K) in the ink cartridge 150K to acquire the manufacturing date stored in the memory 153K in the ink cartridge 150K.

Then, the determination unit 101 calculates a recommended use-by date of the ink cartridge 150K based on the manufacturing date acquired through the wireless communication and the recommended stop period of the ink cartridge 150K stored in the memory 11 (Step S120).

Next, the determination unit 101 determines whether or not the current date is past the recommended use-by date of the ink cartridge 150K, based on the manufacturing date stored in the memory 153K in the ink cartridge 150K, the recommended use-by date of the ink cartridge 150K and the number of days that have elapsed since the manufacturing date of the ink cartridge 150K, which is counted by the timer 13 (Step S130).

When it is determined in Step S130 that the current date is not past the recommended use-by date (NO), the processing is terminated without issuing any warning since the ink cartridge 150K is still in the normal consumption period.

On the other hand, when it is determined in Step S130 that the current date is past the recommended use-by date (YES), the determination unit 101 determines whether or not the current date is past the use-by date (Step S135).

When it is determined in Step S135 that the current date is not past the use-by date (NO), the determination unit 101 determines whether or not there is a warning history by accessing the memories 153K to 153Y through wireless communication (Step S140). As described above, as for warning information, an initial value thereof is a “null” value (blank) and, once a warning is issued, the date of the issuance of the first warning is written as the warning information. Therefore, if there is a warning history, it means that a warning has been issued before, and if there is no warning history, it means that there has been no warning issued.

When it is determined in Step S140 that there is a warning history (YES), it means that a warning has been issued before, and thus the notification unit 102 determines, based on the warning history (warning information), whether or not a warning cycle or more has passed since the point of issuance of the last warning (Step S150). For example, when the warning cycle is set to “2” (i.e., when the warning cycle is set to two months), the notification unit 102 determines whether or not the current month is two months after the month including the point of issuance of the last warning.

When it is determined in Step S150 that the warning cycle or more has not passed since the point of issuance of the last warning (NO), the processing is terminated without issuing any warning, in order to prevent the user from being bothered with warning display.

On the other hand, when it is determined in Step S150 that the warning cycle or more has passed since the point of issuance of the last warning (YES), it can be presumed that a certain amount of time that does not bother the user has passed since the point of issuance of the last warning. Thus, the notification unit 102 displays a message as a warning on the operation panel 12, the message indicating that the ink cartridge is close to its use-by date, as shown in the warning screen example 204 in FIG. 5, for example (Step S160).

Next, the notification unit 102 stores the warning information in the memory 153K in the ink cartridge 150K (Step S170). To be more specific, when no warning information is stored in the memory 153K, i.e., when the warning information is a “null” value (blank), the notification unit 102 writes the date of the issuance of the first warning as the warning information. On the other hand, when the warning information is stored in the memory 153K, the notification unit 102 overwrites and updates the stored warning information with the latest date (most recent date) of warning issuance as the warning information.

Then, when the user presses the in-stock button 204b in the warning screen example 204 on the operation panel 12 (Step S180; YES), the controller 10 stores in-stock information in the memory 153K in the ink cartridge 150K. This shows that the ink cartridge is in stock without encouraging the user to arrange for order. Thus, no warnings are to be issued from the next time.

On the other hand, when the user presses the OK button 204a in the warning screen example 204 on the operation panel 12 in Step S180 (Step S180; NO), the warning displayed on the operation panel 12 is deleted without storing in-stock information (Step S190).

Meanwhile, when it is determined in Step S135 that the current date is past the use-by date (YES), the notification unit 102 displays a message as an error on the operation panel 12, the message indicating that the ink cartridge is past its use-by date as shown in the error screen example 205 in FIG. 5 (Step S210).

Then, when replacement of the ink cartridge 150 is detected (Step S220; YES), the notification unit 102 deletes the error displayed on the operation panel 12 (Step S230). In other words, the ink-jet printer 1 cannot be used until the ink cartridge is replaced in the processing of Step S220.

Meanwhile, when the manager logs in next after the in-stock information is stored in the memory 153K in Step S190 (S100; YES), it is determined in Step S110 that the ink cartridge 150K is in stock (YES). Thus, the determination unit 101 determines whether or not the current date is past the use-by date (Step S115). The controller 10 moves the processing to Step S210 when it is determined that the current date is past the use-by date (YES), and terminates the processing when it is determined that the current date is not past the use-by date (NO).

As described above, in the ink-jet printer 1 according to the embodiment of the present invention, the authentication unit 103 authenticates the consumables manager who manages the ink cartridge 150. Then, the determination unit 101 determines whether or not the ink cartridge 150K is past the recommended use-by date, which is calculated based on the manufacturing date stored in the memory 153K in the ink cartridge 150K, the recommended stop period of the ink cartridge 150K stored in the memory 11, and the like, based on the recommended use-by date and the number of days that have elapsed since the manufacturing date of the ink cartridge 150K, which is counted by the timer 13. If the authentication unit 103 authenticates the consumables manager and the determination unit 101 determines that the ink cartridge 150K is past the recommended use-by date, the notification unit 102 notifies the consumables manager of a warning under predetermined conditions.

Here, the predetermined conditions mean that either one of the conditions “when no warning information is stored in the memory 153K in the ink cartridge 150K” and “when warning information is stored in the memory 153K in the ink cartridge 150K, and the warning cycle has passed since the notification point” is satisfied.

Therefore, a warning is issued when the authenticated consumables manager is authenticated. Thus, regardless of a general user authentication operation and the like, the consumables manager can be appropriately notified that the consumable item is close to time for replacement.

However, when the warning information is stored in the memory 153K, the notification unit 102 notifies a warning if the warning cycle has passed since the notification point. Accordingly, a warning is not issued every time the consumables manager logs in. Thus, at appropriate timing, the consumables manager can be notified that the ink cartridge is close to its use-by date. In addition, the consumables manager can be prevented from being bothered by warning issuance.

Moreover, when the authentication unit 103 authenticates the consumables manager and the determination unit 101 determines that that the ink cartridge is past the recommended use-by date, the notification unit 102 notifies the authenticated consumables manager of warning contents if no in-stock information is stored in the memory 153 in addition to the predetermined conditions described above. Therefore, no warnings are notified if the consumable item is in stock. Thus, the consumables manager can be further prevented from being bothered by the notification of warnings.

Note that the ink-jet printer 1 according to the embodiment of the present invention includes the memory 153 for each of the ink cartridges 150K, 150C, 150M and 150Y. The memory 153 stores the manufacturing date of the ink cartridge 150, the remaining level of the ink stored in the ink bottle 151, warning information indicating the date of issuance of a warning, and in-stock information on the ink cartridge 150. Meanwhile, the memory 11 on the main body side stores the warning cycle, the normal consumption period indicating a period for which the ink cartridge 150 is normally usable and the recommended stop period that is a period in which replacement of the ink cartridge 150 is recommended, for each of the ink cartridges 150K, 150C, 150M and 150Y, and the authentication information for authenticating the consumables manager. However, the present invention is not limited thereto.

The authentication information may be stored in the memory 11, while the manufacturing date, the remaining ink level, the warning information, the in-stock information, the normal consumption period, the recommended stop period and the warning cycle may be stored either in the memory 11 or in the memory 153. Furthermore, the various data described above may be stored either in the memory 11 or in the memory 153. Moreover, which one of the memories is to be used to store such information and data can be arbitrarily decided by the shipment.

When the determination unit 101 determines that the ink cartridge is past the recommended use-by date and when the warning cycle has passed since the warning point of the last warning issuance, based on the warning information stored in the memory 153K in the ink cartridge 150K and the warning cycle stored in the memory 11, the notification unit 102 displays a message as a warning on the operation panel 12, the message indicating that the ink cartridge is close to its use-by date. However, the notification of the warning is not limited to the display on the operation panel 12. For example, an audio speaker may be provided to perform audio output of warning contents from the audio speaker.

Moreover, in the ink-jet printer 1 according to the embodiment of the present invention, the point when the normal consumption period has passed since the manufacturing date is the recommended use-by date. Also, the point when the recommended stop period has passed since the recommended use-by date is calculated as the use-by date. However, the present invention is not limited thereto. For example, a period obtained by multiplying the warning cycle by a predetermined number of times (e.g., 5 times or the like) may be calculated as the recommended stop period. Also, the point when the recommended stop period has passed since the recommended use-by date may be calculated as the use-by date. Moreover, the user may change the settings for the use-by date according to the usage environment.

Furthermore, the use-by date may be calculated by adding a quality guaranteed period, that is a period for which the quality is guaranteed, to the manufacturing date. Alternatively, the use-by date may be set, by calculation from the manufacturing date, as a date up to which the quality of the ink stored in the ink cartridge is guaranteed, and a date that goes back for the recommended stop period from the use-by date may be set as the recommended use-by date.

Note that the ink cartridge 150 attached to the ink-jet printer 1 can achieve the effects of the present invention even when newly attached to another ink-jet printer 1.

To be more specific, when the ink cartridge is attached to another ink-jet printer, it can be determined, using the manufacturing date, warning information and in-stock information stored in the memory 153, whether or not the ink cartridge is past the recommended use-by date, whether or not the notification cycle has passed since the notification point and whether or not the ink cartridge is in stock.

In this event, when the warning cycle in the memory 11 in the main body device is changed, the notification processing described above is performed using the changed warning cycle.

### Modified Example 1

Next, modified example 1 of the present invention is described. In the above embodiment, a warning is issued when the consumables manager logs in for the first time after the warning cycle (predetermined period) has passed. In this modified example, on the other hand, a date of issuance of a warning is further stored as an issuance date, and a warning is issued at or after the issuance date. Note that this modified example is applied to the case where the current date is included in the recommended stop period, and a warning is the second warning or one subsequent thereto. This is because the time before the use-by date is often long for the first warning, and thus it is considered that there is less need to order the ink cartridge.

More specifically, although not shown, the memory 11 stores a warning cycle that is a first predetermined period indicating a period of one or a multiple of one month (one month to several months), and a second predetermined period included in the first predetermined period.

Then, if the authentication unit authenticates the consumables manager and the determination unit 101 determines that a consumable item is past the recommended use-by date, the notification unit 102 issues a warning to the consumables manager if no warning information is stored in the memory 153. Instead, if the warning information is stored in the memory 153, the warning cycle has passed since the notification point, and the current date is after the second predetermined period (the issuance date described above) in the month within the first predetermined period corresponding to the current timing, the notification unit 102 issues a warning to the consumables manager. Note that the second predetermined period represents a period from a certain point to a certain point, but also represents a point by minimizing the period from a certain point to a certain point. Thus, the second predetermined period includes not only the period but also a certain point (timing).

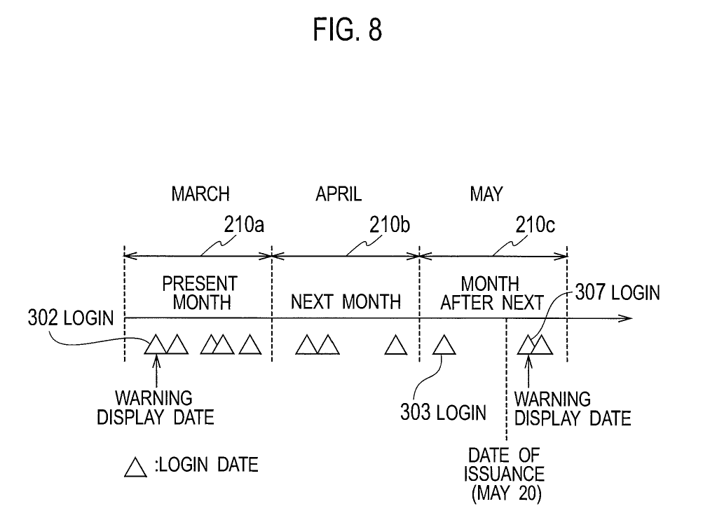

FIG. 8 is a diagram explaining in detail operations of the notification unit 102 in modified example 1 of the present invention.

In FIG. 8, for the purpose of illustration, it is assumed that a month 210a is “3” (March), a month 210b is “4” (April) and a month 210c is “5” (May).

In the memory 11, “2” (months) is stored beforehand as a warning cycle, and “20” (date) is stored as the issuance date for issuing a warning, which is the second predetermined period (date).

It is assumed, for example, that the notification unit 102 displays a message, on the operation panel 12, indicating that the ink cartridge 150K is close to its use-by date, when a login 302 of the consumables manager is operated in March.

Thereafter, no warnings are issued until two months pass from the point when the last warning is issued, i.e., when the login 302 of the consumables manager is operated, even if a login operation of the consumables manager is performed. In other words, no warnings are issued when a login operation of the consumables manager is performed in March after the point when the login 302 of the consumables manager is operated or when a login operation of the consumables manager is performed in April.

Then, the second warning is issued when two months have passed since March that is the month in which the login 302 of the consumables manager notified of the last warning is operated, and the consumables manager logs in for the first time after “20” (date) that is the issuance date in May (after May 20), i.e., when a login 307 of the consumables manager is operated.

Here, the point when a login 303 of the consumables manager is operated is not past the issuance date. Thus, no warning is issued.

As described above, the memory 11 stores a period of one or a multiple of unit period, as the warning cycle of the month for warning by the notification unit 102, and also stores the second predetermined period (timing) (date) for warning by the notification unit 102 as the issuance date. When the notification date is past in the month after the number of months indicated by the warning cycle from the month including the issuance point, the notification unit 102 issues a warning that the ink cartridge is close to its use-by date. Thus, particularly in such a case as where consumables management is performed using a purchase management system for replenishing ink cartridges once a month, the consumables manager can be further prevented from feeling bothered.

When the purchase management system is introduced, the system is often operated such that the consumables manager places an order for a consumable item on a fixed date (order date) every month. Moreover, in the notification described above, it is notified that the use-by date is close. Here, the fact that the warning contents are notified and the use-by date is close means that there is a possibility of placing an order for the consumable item in the purchase management system. Therefore, the consumables manager finds it convenient if the notification timing of the warning contents is linked to placing an order for the consumable item by the purchase management system.

For example, in the notification of second warning output or one subsequent thereto, which is closer to the use-by date, the second predetermined period (e.g., week or date) described above is set to the order date of the consumable item or a date slightly earlier than the order date (e.g., three days earlier, one week earlier, or the like), for example. Thus, once the warning contents are outputted, the consumables manager can be prevented from forgetting to place an order and can immediately place an order for the consumable item, which is convenient in placing an order.

For example, when the purchase management system is operated such that ink cartridges are ordered for restocking according to the stock status of the ink cartridges on the 25th every month, if the first warning display is performed on the 1st or 2nd at the beginning of a month and then the warning display is repeatedly performed every time a login operation of the consumables manager is performed, such warning display is nothing but troublesome to the consumables manager, since no order for a consumable item is to be placed anyway until the 25th (order date) and such warning display may cause the consumables manager to forget to place an order.

In modified example 1 of the present invention, on the other hand, no warning is issued, even if a login operation of the consumables manager is performed on the 1st or 2nd at the beginning of a month, since the issuance date is not past.

Then, a warning is issued when the consumables manager logs in for the first time after “20” (date) that is the issuance date is past (May 20 is past). In other words, the first warning is issued immediately before the 25th (order date). Thus, the consumables manager does not feel bothered by such warning display.

Note that the issuance date that is the second predetermined period described above may be set as the order date for the ink cartridge 150 that is a consumable item, for example, or may be set to the date that is a predetermined number of days after the order date for the ink cartridge 150. Alternatively, the second predetermined period described above may be set to a predetermined number of days or one week before or after the order date for the ink cartridge 150, for example.

Note that the issuance date that is the second predetermined period may be reset so that a warning is to be issued at timing within a predetermined number of days before or after the order date, based on a history of warnings actually issued to the consumables manager for the order date. For example, when a warning history in the past is set to be acquired and it is convenient for the consumables manager to place an order if the issuance date is set to several days before the order date, such as when the warning issuance date is often the 13th to 15th and the order date is the 18th, based on the warning history, the issuance date may be set between the 15th and 18th (in this event, the issuance date may be automatically set or may be notified to the consumables manager and set based on an operation by the consumables manager).

Here, as the contents of the warning displayed, the necessity to order the ink cartridge 150 may be displayed.

Moreover, in modified example 1 of the present invention, the description is given of the case where the first predetermined period is the period of one or a multiple of one month, and the second predetermined period (timing) is the date. However, the present invention is not limited thereto. For example, the second predetermined period may be the week while the first predetermined period is the period of one or a multiple of one month. For example, when the second predetermined period is set to the second week, a warning is to be issued in or after the second week in the month after the first predetermined period.

Moreover, although the description is given here taking the order date as an example, other dates or the like regarding consumables management may be used as the second predetermined period.

### Modified Example 2

Next, modified example 2 of the present invention is described. In the above embodiment, the warning is issued when the consumables manager logs in for the first time after the warning cycle has passed. On the other hand, in this modified example, a warning cycle is set such that the closer to the use-by date of the ink cartridge, the shorter the warning cycle, based on a period past the recommended use-by date for a period (recommended stop period) between the recommended use-by date and the use-by date.

As described above, the duration of use is set as the period for which the quality of the ink cartridge 150 is guaranteed. When the use-by date that is the end point of the duration of use is past, the ink cartridge 150 can no longer be used even if ink is still left therein. Therefore, when the remaining ink level is high even though the use-by date is approaching, it is preferable to increase the frequency of warnings to notify that the use-by date of the ink cartridge 150 is approaching, and to display a message encouraging the user to use up the ink in the ink cartridge 150 soon.

Therefore, in modified example 2 of the present invention, the warning cycle stored in the memory 11 is set such that the closer to the use-by date of the ink cartridge 150, the shorter the warning cycle. For example, when the time before the use-by date of the ink cartridge 150 is four months or more, the warning cycle is set to “2” (months). When the time before the use-by date of the ink cartridge 150 is two months or more and less than four months, the warning cycle is set to “1” (month). When the time before the use-by date of the ink cartridge 150 is zero months or more and less than two months, the warning cycle is set to “0.5” (months).

Moreover, in modified example 2 of the present invention, the memory 11 stores display contents according to the use-by date of the ink cartridge 150. For example, when the time before the use-by date of the ink cartridge 150 is four months or more, the display content is “Use up soon.” When the time before the use-by date of the ink cartridge 150 is two months or more and less than four months, the display content is “Use-by date is approaching. Use up soon.” When the time before the use-by date of the ink cartridge 150 is zero months or more and less than two months, the display content is “Use-by date soon. Use up as soon as possible.”

Accordingly, the consumables manager is encouraged to use the ink at timing approaching the use-by date. Thus, by encouraging the use of the ink from the consumables manager to general users, the ink can be efficiently consumed without any waste during the duration of use.

### Modified Example 3

Next, modified example 3 of the present invention is described. In modified example 2, the warning cycle is set such that the closer to the use-by date of the ink cartridge, the shorter the warning cycle, based on the period past the recommended use-by date for the period (recommended stop period) between the recommended use-by date and the use-by date.

In this modified example, a warning cycle is set according to the period past the recommended use-by date for the period between the recommended use-by date and the use-by date, such that the higher the remaining level of usable ink, the shorter the warning cycle. For example, when the remaining ink level in the ink cartridge 150 is 30(%) or more, the warning cycle is set to “0.5” (months). When the remaining ink level in the ink cartridge 150 is 20(%) or more and less than 30(%), the warning cycle is set to “1” (month). When the remaining ink level in the ink cartridge 150 is 10(%) or more and less than 20(%), the warning cycle is set to “2” (months).

Furthermore, modified example 3 can also be combined with modified example 2. To be more specific, when the time before the use-by date of the ink cartridge 150 is four months or more and the remaining ink level in the ink cartridge 150 is 10(%) or more and less than 20(%), the warning cycle is set to “2” (months). When the time before the use-by date of the ink cartridge 150 is two months or more and less than four months and the remaining ink level in the ink cartridge 150 is 20(%) or more and less than 30(%), the warning cycle is set to “1” (month). When the time before the use-by date of the ink cartridge 150 is zero months or more and less than two months and the remaining ink level in the ink cartridge 150 is 30(%) or more, the warning cycle is set to “0.5” (months).

Note that the present invention is not limited thereto, but the warning cycle may be determined by appropriately combining the remaining ink level and the time before the use-by date. More specifically, the higher the remaining ink level and the closer to the use-by date, the shorter the warning cycle. The lower the remaining ink level and the farther away from the use-by date, the longer the warning cycle. To be more specific, as to whether to prioritize the remaining ink level or the time before the use-by date for various combinations of “high remaining ink level” and “low remaining ink level” with “far use-by date” and “close use-by date”, the warning cycle may be determined by weighting the remaining ink level and the time before the use-by date, respectively. For example, when priority is placed on the time before the use-by date, the warning cycle when the time before the use-by date is short and the remaining ink level is low may be set to be shorter than that when the time before the use-by date is long and the remaining ink level is high.

Moreover, in modified example 3 of the present invention, the memory 11 stores display contents according to the use-by date of the ink cartridge 150 and the remaining ink level. For example, when the remaining ink level in the ink cartridge 150 is 30(%) or more, the display content is “Still a lot of ink left. Use up soon.” When the remaining ink level in the ink cartridge 150 is 20(%) or more and less than 30(%), the display content is “Ink left. Use up soon.” When the remaining ink level in the ink cartridge 150 is 10(%) or more and less than 20(%), the display content is “Still a little ink left. Use up.”

Accordingly, the consumables manager is encouraged to use the ink when the remaining ink level is high at timing approaching the use-by date. Thus, by encouraging the use of the ink from the consumables manager to general users, the ink can be efficiently consumed without any waste during the duration of use.

### Modified Example 4

Next, modified example 4 of the present invention is described. In the above embodiment, when the authentication unit 103 authenticates the consumables manager, it is determined whether or not the ink cartridge is past the recommended use-by date, based on the manufacturing date of the ink cartridge, the recommended use-by date before the use-by date of the ink cartridge, and the number of days that have elapsed since the manufacturing date. Then, when it is determined that the ink cartridge is past the recommended use-by date, a warning is displayed, indicating that the ink cartridge is close to its use-by date. In this modified example, on the other hand, the recommended use-by date is set for each region where the ink-jet printer 1 is installed.

The memory 11 further stores a region table in which a region code indicating the region and a normal consumption period, which is a period from the manufacturing date to the recommended use-by date, are associated with each other. For example, “JP” that is the region code indicating Japan and “18” (months) that is the normal consumption period are associated with each other. Also, “AF” that is the region code indicating Africa and “24” (months) that is the normal consumption period are associated with each other. Thus, the region codes and the normal consumption periods are stored as the region table.

Then, the determination unit 101 extracts the normal consumption period of the ink cartridge 150 corresponding to the region code inputted from the operation panel 12, for example, from the region table stored in the memory 11, and calculates the recommended use-by date of the ink cartridge 150 based on the extracted normal consumption period and the manufacturing date acquired through wireless communication.

Thus, since it can be presumed that the ink deteriorates fast in a hot region, the recommended stop period is set long so that the ink cartridge 150 can be replaced soon. On the other hand, since it can be presumed that the ink is less likely to deteriorate in a cold region, the recommended stop period can be set short. Thus, appropriate recommended stop periods can be set according to the region.

### Modified Example 5

Next, modified example 5 of the present invention is described. In the above embodiment, the notification unit 102 displays a message as a warning on the operation panel 12, the message indicating that the ink cartridge 150 is close to its use-by date, when the warning cycle set to the value obtained by multiplying the month by one or a multiple thereof has passed since the warning point when the warning had been issued. However, the warning cycle is not limited to the period of one or a multiple of one month, but may be set in the unit of day.

For example, when the warning cycle is set to “40”, the notification unit 102 displays a message as a warning on the operation panel 12, the message indicating that the ink cartridge 150 is close to its use-by date, when 40 days have passed since the warning point when the warning had been issued.

Thus, by simple day counting, it can be determined whether or not the ink cartridge 150 is past the recommended use-by date.

### Modified Example 6

Next, modified example 6 of the present invention is described. In the above embodiment, when the authentication unit 103 authenticates the consumables manager, the determination unit 101 determines whether or not the ink cartridge 150 is past the recommended use-by date, based on the manufacturing date, the recommended use-by date before the use-by date, and the number of days that have elapsed since the manufacturing date, for each of the ink cartridges 150K, 150C, 150M and 150Y. Then, when the ink cartridge 150 is past the recommended use-by date and the warning cycle has passed since the warning point of the last warning issuance, the notification unit 102 displays a message as a warning on the operation panel 12, the message indicating that the ink cartridge 150 is close to its use-by date.

In this event, if some of the ink cartridges 150K, 150C, 150M and 150Y are past their recommended use-by dates and the warning cycle has passed since the warning point of the last warning issuance, warnings for these ink cartridges may be displayed on the same display screen of the operation panel 12 at the same time, or may be displayed in order from the ink cartridge closer to the use-by date.

Furthermore, the user may set whether to display the warnings on the same display screen of the operation panel 12 at the same time, or to display the warnings in order from the ink cartridge closer to the use-by date.

### Modified Example 7

Next, modified example 7 of the present invention is described. In the above embodiment, the memory 11 stores the recommended stop period and normal consumption period indicating the period for which the ink cartridge can be used, for each of the ink cartridges 150K, 150C, 150M and 150Y. However, any one of or both of the recommended stop period and the normal consumption period may be set according to preset quality ranks.

For example, in modified example 6 of the present invention, the recommended stop period and the normal consumption period may be set to differ according to the color of ink. Alternatively, the recommended stop period and the normal consumption period may be set to differ according to the manufacturing method, even if the color of ink is the same.

Furthermore, the display contents of the warning may be changed according to the color of ink and the manufacturing method.

### Modified Example 8

Next, modified example 8 of the present invention is described. In the above embodiment, when the authentication unit 103 authenticates the consumables manager, the determination unit 101 determines whether or not the ink cartridge 150 is past the recommended use-by date, based on the manufacturing date, the recommended use-by date, and the number of days that have elapsed since the manufacturing date, for each of the ink cartridges 150K, 150C, 150M and 150Y. However, the present invention is not limited thereto.

In modified example 8 of the present invention, the memory 153 stores a use start date of the ink cartridge 150, in addition to the manufacturing date when the ink cartridge 150 was manufactured, the remaining level of the ink stored in the ink bottle 151, the warning information indicating the date of the warning issuance, and the in-stock information of the ink cartridge 150. Here, the use start date of the ink cartridge 150 is the date when the ink cartridge 150 is attached to the main body device.

Then, the determination unit 101 determines whether or not the ink cartridge 150 is past the recommended use-by date, based on the use start date, the recommended use-by date, and the number of days that have elapsed since the use start date, for each of the ink cartridges 150K, 150C, 150M and 150Y. To be more specific, the point when the normal consumption period has passed since the use start date is calculated as the recommended use-by date, and the point when the recommended stop period has passed since the recommended use-by date is calculated as the use-by date.

Thus, it is determined whether or not the ink cartridge 150 is past the recommended use-by date, based on the time that has passed since the point where the ink cartridge 150 is actually opened, attached to the main body device and used. Thus, management more suited to actual usage pattern can be performed.

### Modified Example 9

In the above embodiment, the description is given of the case using the ink-jet printer 1 and the ink cartridges 150. However, the present invention is not limited thereto. For example, the present invention is also applicable using a stencil printing machine instead of the ink-jet printer 1, ink containers attached to drums instead of the ink cartridges 150, and tag information (memory) attached to a stencil sheet roll. Moreover, the present invention is applicable to any kind of printers using consumable items, such as an electrophotographic printer, besides the stencil printing machine.

### Modified Example 10

Although the recommended use-by date is set for each region where the ink jet printer 1 is installed in modified example 4, the present invention is not limited thereto. In this modified example, the ink-jet printer 1 may include a temperature sensor for measuring an outside air temperature and a temperature condition storage unit configured to store a correspondence table in which a temperature range and a normal consumption period are associated with each other. The normal consumption period corresponding to the outside air temperature measured by the temperature sensor may be extracted from the correspondence table, and the recommended use-by date may be calculated based on the normal consumption period. Then, the determination unit 101 may determine whether or not the ink cartridge 150 is past the calculated recommended use-by date.

Thus, the recommended use-by date can be appropriately set according to the ambient temperature.

### Modified Example 11

In this modified example, the consumables manager can freely set how to display a warning.

To be more specific, when the authentication unit 103 authenticates the consumables manager and the determination unit 101 determines that the ink cartridge 150 is past the recommended use-by date, the notification unit 102 may display a message as a warning on the operation panel 12, the message indicating that the ink cartridge is close to its use-by date, if no warning information is stored in the memory 153K in the ink cartridge 150K or if the warning information is stored in the memory 153K in the ink cartridge 150K, the warning cycle has passed since the warning point when the warning had been issued, and setting conditions set by the consumables manager are met.

Here, as for the conditions set by the consumables manager, issuance of a warning may be set to be performed every other time with respect to the warning timing by an operation by the consumables manager, for example.

Thus, since the warning can be issued considering the settings by the consumables manager, control on which characteristics of the consumables manager are more accurately reflected can be performed.

As to the warning within the recommended stop period, the consumables manager may use the operation panel to set the warnings not to be issued, so that no further warnings are to be issued after several warnings are issued.

Although the embodiment of the present invention has been described above, the respective functions described can be implemented by one or more processing circuits. The processing circuits include a programmed processor, an electric circuit, and the like. The processing circuits further include a device such as application specific integrated circuits (ASIC), circuit elements disposed so as to execute the functions described above, and the like.

Moreover, the above embodiments are described to facilitate understanding of the present invention, and are for illustrative purposes only. The present invention is not limited to those embodiments. The technical scope of the present invention is not limited to specific technical matters disclosed in the embodiments described above, and includes various modifications, changes, alternative techniques, and the like which can be easily derived therefrom.

This application claims priority based on Japanese Patent Application No. 2014-133969, filed on Jun. 30, 2014; the entire contents of which are incorporated herein by reference.

According to the printer and the consumable item according to the present invention, when the authentication unit authenticates the consumables manager and the determination unit determines that the consumable item is past the recommended use-by date, a warning content indicating that the consumable item is close to the use-by date is notified to the authenticated consumables manager if no notification point is stored in the storage unit or if the notification point is stored in the storage unit and the notification cycle has passed since the notification point. Thus, at appropriate timing, the consumables manager can be notified that the consumable item is close to the use-by date. In addition, the consumables manager can be prevented from being bothered by warning issuance.

What is claimed is:

1. A printer comprising:
a main body device configured to perform printing;
a consumable item detachably attached to the main body device and used for printing;
an authentication unit configured to authenticate a consumables manager who manages the consumable item;
a determination unit configured to determine whether or not the consumable item is past a recommended use-by date which is to come before a use-by date of the consumable item, based on a manufacturing date or use start date of the consumable item, the recommended use-by date, and time that has passed since the manufacturing date or use start date of the consumable item;
a notification unit configured to notify the authenticated consumables manager of a warning content indicating that the consumable item is close to the use-by date, under a predetermined condition if the authentication unit authenticates the consumables manager and the determination unit determines that the consumable item is past the recommended use-by date; and
a storage unit configured to store an interval of notification by the notification unit as a notification cycle, and store a notification point of the most recent notification by the notification unit after the recommended use-by date, wherein
the predetermined condition includes
when the notification point is not stored in the storage unit, or
when the notification point is stored in the storage unit and the notification cycle has passed since the notification point.

2. The printer according to claim 1, wherein
the storage unit stores
the notification cycle that is a first predetermined period indicating a period of one or a multiple of unit period, and
a second predetermined period included in the first predetermined period, and
the predetermined condition includes
when the notification point is not stored in the storage unit, or
when the notification point is stored in the storage unit, the notification cycle has passed since the notification point, and the current timing is after the second predetermined period within the first predetermined period corresponding to the current timing.

3. The printer according to claim 1, further comprising:
a stock information storage unit configured to store in-stock information indicating that the consumable item is in stock, wherein
if the authentication unit authenticates the consumables manager and the determination unit determines that the consumable item is past the recommended use-by date, the notification unit notifies the authenticated consumables manager of the warning content under the predetermined condition and additionally under a condition where the in-stock information is not stored in the stock information storage unit.

4. A consumable item detachably attached to a main body device, the main body device including:
an authentication unit configured to authenticate a consumables manager who manages the consumable item;
a determination unit configured to determine whether or not the consumable item is past a recommended use-by date which is to come before a use-by date of the consumable item, based on a manufacturing date or use start date of the consumable item, the recommended use-by date, and time that has passed since the manufacturing date or use start date of the consumable item;
a notification unit configured to notify a warning content indicating that the consumable item is close to the use-by date, under a predetermined condition if the authentication unit authenticates the consumables manager and the determination unit determines that the consumable item is past the recommended use-by date; and
a storage unit configured to store an interval of notification by the notification unit as a notification cycle,
the consumable item comprising:
a notification point storage unit configured to store a notification point of the most recent notification by the notification unit after the recommended use-by date, as notification point information, wherein
the predetermined condition includes
when the notification point information is not stored in the notification point storage unit, or
when the notification point information is stored in the notification point storage unit and the notification cycle has passed since the notification point.

5. The consumable item according to claim 4, wherein
the storage unit stores the notification cycle that is a first predetermined period indicating a period of one or a multiple of unit period, and a second predetermined period included in the first predetermined period, and
the predetermined condition includes
when the notification point information is not stored in the notification point storage unit, or
when the notification point information is stored in the notification point storage unit, the notification cycle has passed since the notification point, and the current timing is after the second predetermined period within the first predetermined period corresponding to the current timing.

6. The consumable item according to claim 4, further comprising:
a stock information storage unit configured to store in-stock information indicating that the consumable item is in stock, wherein
if the authentication unit authenticates the consumables manager and the determination unit determines that the consumable item is past the recommended use-by date, the notification unit notifies the authenticated consumables manager of the warning content under the predetermined condition and additionally under a condition where the in-stock information is not stored in the stock information storage unit.
